(19) United States
(12) Patent Application Publication
(10) Pub. No.: US 2017/0200540 A1
(43) Pub. Date: Jul. 13, 2017

(54) MAGNETIC METAL POWDER-CONTAINING SHEET, METHOD FOR MANUFACTURING INDUCTOR, AND INDUCTOR

(71) Applicant: Murata Manufacturing Co., Ltd., Nagaokakyo-shi (JP)

(72) Inventors: YOSHIYUKI MORIUCHI, Nagaokakyo-shi (JP); Takashi Tomohiro, Nagaokakyo-shi (JP); Mitsuhiro Fukushima, Nagaokakyo-shi (JP)

(21) Appl. No.: 15/397,189

(22) Filed: Jan. 3, 2017

(30) Foreign Application Priority Data
Jan. 8, 2016 (JP) 2016-002697

(51) Int. Cl. H01F 1/147; H01F 41/02; H01F 27/28; H01F 27/245; H01F 27/255; H01F 27/29; B29C 69/00; H01F 41/04

(52) U.S. Cl. CPC H01F 1/14791; B29C 69/001; H01F 41/0233; H01F 41/04; H01F 27/245; H01F 27/255; H01F 27/29; H01F 27/2823; B29C 2793/0081; B29K 2063/00

(57) ABSTRACT

A magnetic metal powder-containing sheet contains a magnetic metal powder, a phenoxy resin, and an epoxy resin. The content of the phenoxy resin is 50 parts by weight to 150 parts by weight per 100 parts by weight of the epoxy resin.

### CROSS REFERENCE TO RELATED APPLICATIONS

The present application claims priority to Japanese Patent Application No. 2016-002697, filed Jan. 8, 2016, the entire contents of which is incorporated herein by reference.

### BACKGROUND OF THE INVENTION

Field of the Invention

The present invention relates to a magnetic metal powder-containing sheet, a method for manufacturing an inductor, and an inductor.

Description of the Related Art

A known inductor includes a magnet made of a magnetic metal powder rather than a ferrite ceramic.

Japanese Unexamined Patent Application Publication No. 2014-11467 (hereinafter referred to as the patent document) discloses a metal-polymer composite film, made of a filmy mixture containing a metal powder and an amorphous epoxy resin, for inductors. The patent document also describes a method for manufacturing an inductor using the metal-polymer composite film.

In the method for manufacturing the inductor described in the patent document, the metal-polymer composite film is stacked on a coil layer, is pressure-bonded thereto, and is cured, followed by cutting with a dicer, whereby a plurality of inductors are manufactured.

In the above step, a filmy mixture, which contains the metal powder and the amorphous epoxy resin, is used as a metal-polymer composite. Cutting the cured filmy mixture with a dicer has caused particle shedding that is a phenomenon in which particles in a metal powder are shed.

Observing the surface of a cured product suffering particle shedding has shown that the portions suffering from particle shedding are cavities formed in cured resin.

The inventors have measured an inductor suffering particle shedding for characteristics and have found that the flexural strength and L-value thereof are low.

### SUMMARY OF THE INVENTION

The present invention has been made to solve the above problem. It is an object of the present invention to provide a magnetic metal powder-containing sheet useful in manufacturing an inductor which is unlikely to suffer particle shedding when a cured product is cut with a dicer or is surface-polished and which is excellent in flexural strength and L-value.

According to preferred embodiments of the present invention, a magnetic metal powder-containing sheet contains a magnetic metal powder, a phenoxy resin, and an epoxy resin. The content of the phenoxy resin is 50 parts by weight to 150 parts by weight per 100 parts by weight of the epoxy resin.

Since the magnetic metal powder-containing sheet contains 50 parts by weight or more of the phenoxy resin, particle shedding is suppressed and a cured product obtained by curing the magnetic metal powder-containing sheet has high flexural strength. Suppressing particle shedding leads to a high L-value.

Furthermore, suppressing particle shedding exhibits the effect of enhancing the adhesion between the cured product and outer electrodes attached thereto.

When the content of the phenoxy resin is 150 parts by weight or less, the magnetic metal powder-containing sheet is easily formed, which is preferred.

In the magnetic metal powder-containing sheet, the content of the magnetic metal powder is preferably 60% by volume to 87% by volume.

The content of the magnetic metal powder is defined as the volume percentage of the magnetic metal powder where the volume of the whole magnetic metal powder-containing sheet is 100% by volume.

Containing 60% by volume or more of the magnetic metal powder leads to an increase in inductor performance. When the content of the magnetic metal powder is 87% by volume or less, the magnetic metal powder-containing sheet has increased flexibility.

In the magnetic metal powder-containing sheet, the cured magnetic metal powder-containing sheet preferably has a flexural strength of 125 MPa or more.

When the flexural strength of the cured magnetic metal powder-containing sheet is high, 125 MPa or more, an inductor excellent in mechanical strength can be manufactured by curing the magnetic metal powder-containing sheet.

According to preferred embodiments of the present invention, a method for manufacturing an inductor includes preparing the above magnetic metal powder-containing sheet, embedding a coil therein, curing the magnetic metal powder-containing sheet with the coil embedded therein to form a cured product, and cutting or polishing the cured product.

Even if cutting (for example, dicing) or polishing (for example, barrel polishing) is performed after the magnetic metal powder-containing sheet is converted into the cured product, particle shedding is suppressed. Therefore, the inductor can be manufactured by the above method so as to have excellent flexural strength and an excellent L-value.

According to preferred embodiments of the present invention, an inductor includes a cured product of the magnetic metal powder-containing sheet and a coil embedded therein.

In the cured product of the magnetic metal powder-containing sheet, which is included in the inductor, particle shedding is suppressed. This allows the inductor to have excellent flexural strength and an excellent L-value.

According to the present invention, a magnetic metal powder-containing sheet can be provided that is useful in manufacturing an inductor which is unlikely to suffer particle shedding when a cured product is cut with a dicer or is surface-polished and which is excellent in flexural strength and L-value.

Other features, elements, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic perspective view showing how a plurality of coils are arranged on a magnetic metal powder-containing sheet and another magnetic metal powder-containing sheet is stacked on the coils;

FIG. 2 is a schematic perspective view showing a dicing step; and

FIG. 3 is a schematic partial perspective view of an inductor obtained by forming outer electrodes.

### DESCRIPTION OF THE PREFERRED EMBODIMENTS

Embodiments of the present invention will now be described.

The present invention is not limited to the embodiments. Appropriate modifications can be made without departing from the scope of the present invention.

The embodiments are for exemplification only. A partial substitution or combination of configurations described in different embodiments can be made.

A combination of two or more preferred configurations of the present invention that are described below is included in the scope of the present invention.

Magnetic Metal Powder-Containing Sheet

A magnetic metal powder-containing sheet, according to an embodiment of the present invention, contains a magnetic metal powder, a phenoxy resin, and an epoxy resin. The content of the phenoxy resin is about 50 parts by weight to about 150 parts by weight per about 100 parts by weight of the epoxy resin.

Magnetic Metal Powder

The magnetic metal powder may be at least one of powders of various magnetic metals. Examples of the magnetic metals include magnetic metal materials such as an Fe—Si—Cr alloy, iron carbonyl, soft magnetic iron (Fe), silicon steel (Fe-3Si), iron-aluminum (Fe-3.5Al), Alperm (Fe-16Al), Permendur (Fe-50Co-2V), Sendust (Fe-9.5Si-5.5Al), 45 permalloy (Fe-45Ni), 78 permalloy (Fe-78.5Ni), supermalloy (Fe-95Ni-5Mo), Mumetal (Fe-77Ni-2Cr-5Cu), Hardperm (Fe-79Ni-9Nb), an iron-based amorphous alloy (Fe-5Si-3B), and a cobalt-based amorphous alloy (Co_{81.8}—Fe_{4.2}—Ni_{4.2}—Si₁₀-B₂₀). The magnetic metal powder may include two or more types of magnetic metal material powders different in average particle size D50. When the magnetic metal powder includes two or more types of powders different in average particle size D50, inductors are capable of densely containing the magnetic metal powder and are likely to have a high L-value.

The lower limit of the content of the magnetic metal powder in the magnetic metal powder-containing sheet is preferably 60% by volume and more preferably 76% by volume. The upper limit thereof is preferably 87% by volume and more preferably 82% by volume.

Phenoxy Resin

In this specification, the phenoxy resin has at least one selected from the group consisting of a bisphenol A skeleton, a bisphenol F skeleton, a bisphenol S skeleton, and a bisphenol acetophenone skeleton. The phenoxy resin may be resin synthesized from epichlorohydrin and bisphenol. Examples of bisphenol include bisphenol A, bisphenol F, bisphenol S, and bisphenol acetophenone. Two or more types of phenoxy resins may be used in combination. The phenoxy resin may be terminated with functional groups such as phenolic hydroxy groups or epoxy groups.

The phenoxy resin has a weight-average molecular weight of 10,000 or more as measured by gel permeation chromatography (GPC). The lower limit of the weight-average molecular weight of the phenoxy resin is preferably 30,000. The upper limit thereof is preferably 1,000,000 and more preferably 200,000.

In this specification, the weight-average molecular weight of resin can be determined in the form of weight average in terms of polystyrene as measured by GPC using, for example, toluene, tetrahydrofuran, acetone, or the like as a developing solvent.

Commercially available examples of the phenoxy resin include a bisphenol A-based phenoxy resin, 1256, available from Japan Epoxy Resin Co., Ltd.; a bisphenol A/bisphenol F-based phenoxy resin, 4250, available from Japan Epoxy Resin Co., Ltd.; a bisphenol S-based phenoxy resin, YX8100, available from Japan Epoxy Resin Co., Ltd.; and a bisphenol F-based phenoxy resin, FX-316, available from Tohto Kasei Co., Ltd.

Epoxy Resin

The epoxy resin has a weight-average molecular weight of less than 10,000 as measured by GPC. The epoxy resin is a liquid epoxy resin, a solid epoxy resin, or a mixture of the liquid and solid epoxy resins. Examples of the epoxy resin include a bisphenol A-type epoxy resin, a bisphenol F-type epoxy resin, a bisphenol S-type epoxy resin, a biphenyl-type epoxy resin, a hydrogenated bisphenol A-type epoxy resin, an alicyclic epoxy resin, an aliphatic epoxy resin, and a naphthalene-type epoxy resin. These epoxy resins may be used alone or in combination. In order to obtain a flexible sheet that can be wound during sheet forming, the epoxy resin used is preferably the liquid epoxy resin.

The liquid epoxy resin is liquid at room temperature (about 25° C.). The solid epoxy resin is solid at room temperature (about 25° C.) and preferably has a softening point of about 120° C. or lower and more preferably about 100° C. or lower in an uncured state.

The epoxy resin preferably has a weight-average molecular weight of 1,000 or less.

In the magnetic metal powder-containing sheet, for the proportion of the phenoxy resin and the epoxy resins, which are resin components, the content of the phenoxy resin is 50 parts by weight to 150 parts by weight per 100 parts by weight of the epoxy resin. The lower limit of the content of the phenoxy resin is preferably 75 parts by weight per 100 parts by weight of the epoxy resin. The upper limit thereof is preferably 125 parts by weight per 100 parts by weight of the epoxy resin.

Other Components

The magnetic metal powder-containing sheet may further contain a curing agent. Examples of the curing agent include dicyandiamide, acid anhydrides, imidazoles, amine curing agents, and phenolic curing agents. These curing agents may be used alone or in combination. The curing agent is preferably a latent curing agent (for example, dicyandiamide) which is suitable for long-term storage and of which the processing temperature is readily adjusted.

The magnetic metal powder-containing sheet may further contain a curing accelerator. Examples of the curing accelerator include imidazoles, amine curing accelerators, organophosphorus curing accelerators, onium salt curing accelerators, metal chelate curing accelerators, and various microencapsulated curing accelerators. These curing accelerators may be used alone or in combination.

The magnetic metal powder-containing sheet may further contain filler such as silica, silicon carbide, alumina, or barium titanate or a flame retardant such as aluminum hydroxide.

The magnetic metal powder-containing sheet may further contain a coupling agent, a dispersant, or the like. Examples of the coupling agent include silane coupling agents such as epoxy silane, mercaptosilane, aminosilane, vinylsilane, styrylsilane, methacryloxysilane, and acryloxysilane; siloxanes such as hexyltrimethoxysilane, methylmethoxysilane, and hexamethyldisilazane; titanates; and aluminates. Examples of the dispersant include alkyl ether dispersants, sorbitan ester dispersants, alkyl polyether amine dispersants, and polymeric dispersants.

The magnetic metal powder-containing sheet may further contain an appropriate additive such as a surface treatment agent, a leveling agent, a low-elasticity rubber component, low-elasticity rubber particles, an adhesion promoter, or a thixotropic agent as required.

The thickness of the magnetic metal powder-containing sheet is not particularly limited. The lower limit of the thickness of the magnetic metal powder-containing sheet is preferably greater than or equal to the maximum particle size of the filler contained therein. The upper limit thereof is preferably about twice the maximum particle size of the filler. When the maximum particle size of the filler is, for example, about 120 μm, the lower limit of the thickness of the magnetic metal powder-containing sheet is preferably about 120 μm and the upper limit thereof is preferably about 240 μm. When the thickness of the magnetic metal powder-containing sheet is within the above range, the magnetic metal powder-containing sheet is suitable for manufacturing an inductor by stacking the magnetic metal powder-containing sheet on a coil.

Characteristics of Cured Product of Magnetic Metal Powder-Containing Sheet

The sufficiently cured magnetic metal powder-containing sheet preferably has a flexural strength of about 125 MPa or more.

The magnetic metal powder-containing sheet can be thermally cured by heating. Preferred curing conditions vary depending on the type of the epoxy and phenoxy resins and the blending ratio of the epoxy and phenoxy resins.

The flexural strength of the sufficiently cured magnetic metal powder-containing sheet can be measured in such a manner that the magnetic metal powder-containing sheet is completely cured by heating, is cut to a size suitable for measurement using a dicer, and is then subjected to a three-point bending test using a flexural strength meter.

Method for Manufacturing Magnetic Metal Powder-Containing Sheet

The magnetic metal powder-containing sheet can be manufactured in such a manner that the above materials are mixed at a predetermined ratio and the mixture is formed into a sheet. Upon mixing, the viscosity of the mixture may be adjusted by adding a solvent to the mixture. Examples of the solvent include methyl ethyl ketone (MEK), N,N-dimethylformamide (DMF), propylene glycol monomethyl ether (PGME), propylene glycol monomethyl ether acetate (PMA), dipropylene glycol monomethyl ether (DPM), dipropylene glycol monomethyl ether acetate (DPMA), and γ-butyrolactone.

A method for forming the sheet is not particularly limited. A mixture containing a resin component that is in an uncured state (A-stage state) is applied to a support substrate composed of a PET film or the like and is then heated, whereby the sheet can be formed on the support substrate so as to contain the resin component that is in a partially cured state (B-stage state). Heating can be performed using, for example, a hot-air dryer.

The resin component in the A-stage state is a component containing the uncured epoxy and phenoxy resins. The resin component in the B-stage state is a component containing the epoxy and phenoxy resins that are not completely cured but is partially cured by heating.

The magnetic metal powder-containing sheet is preferably one containing the resin component in the partially cured state (B-stage state).

Method for Manufacturing Inductor

A method for manufacturing an inductor according to an embodiment of the present invention includes preparing the magnetic metal powder-containing sheet and a coil, preparing a cured product in such a manner that the magnetic metal powder-containing sheet and the coil are stacked and are pressed and the magnetic metal powder-containing sheet is cured, and cutting or polishing the cured product.

In the method for manufacturing the inductor, the cured product is cut (for example, diced) or is polished (for example, barrel-polished).

In the case of preparing a plurality of inductors at a time, after the cured product is prepared, the cured product is cut into the inductors by dicing. The inductors are polished for size adjustment. Since either case includes a step of applying mechanical force to the cured product, particle shedding may possibly arise from the cured product. However, the use of the magnetic metal powder-containing sheet suppresses particle shedding from the cured product.

In the case of preparing the inductors, the cured product can be prepared in such a manner that a substrate provided with a plurality of coils is prepared and the magnetic metal powder-containing sheet is stacked on the coils, is pressed, and is then cured.

In the case of using the substrate, which is provided with the coils, the coils may be arranged on the front and back surfaces of the substrate or may be arranged only on a single surface of the substrate. In the case where the coils are arranged on the front and back surfaces of the substrate, the magnetic metal powder-containing sheet and another magnetic metal powder-containing sheet are placed on the front and back surfaces of the substrate and may be then pressed.

The coils need not be arranged on the substrate. In this case, the coils are arranged on a die, a releasable plate, or a releasable film and the magnetic metal powder-containing sheet is stacked on the coils and is pressed, followed by press forming. In this case, the manufactured inductors have a structure including no substrate.

For example, the coils are arranged and the magnetic metal powder-containing sheet is stacked on the coils and is pressed, followed by primary press forming. This allows at least one portion of each coil is embedded in the magnetic metal powder-containing sheet and the magnetic metal powder-containing sheet is filled in an inner portion of the coil.

Another magnetic metal powder-containing sheet is stacked on a coil-exposed surface of a magnetic sheet, obtained by primary press forming, having the coils embedded therein, followed by secondary press forming. The two magnetic metal powder-containing sheets are combined together by primary press forming and secondary press forming to form magnetic portions of the inductors.

The magnetic metal powder-containing sheet and the coil are stacked and are pressed, whereby the softened magnetic metal powder-containing sheet is filled in a core portion of the coil. As a result, the magnetic metal powder is filled in the core portion of the coil.

The magnetic metal powder-containing sheet is preferably cured by heating. Preferred curing conditions vary depending on the type of the epoxy and phenoxy resins and the blending ratio of the epoxy and phenoxy resins.

A conductive paste for forming outer electrodes is applied to both end surfaces of the inductor manufactured through the above steps and the outer electrodes are formed, whereby the inductor can be manufactured. A plating layer may be further formed on the surface of each outer electrode. The outer electrodes may be formed by sputtering or direct plating without using the conductive paste.

An example of the method for manufacturing the inductor is described below with reference to the attached drawings.

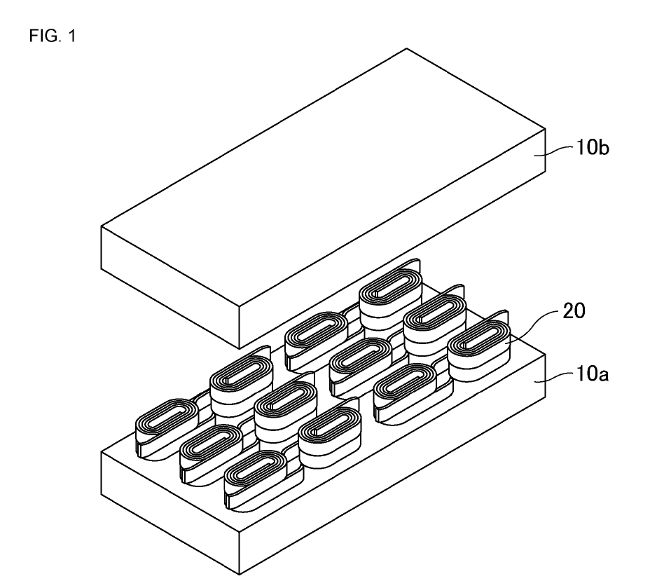

FIG. 1 is a schematic perspective view showing how a plurality of coils are arranged on the magnetic metal powder-containing sheet and another magnetic metal powder-containing sheet is stacked on the coils.

As shown in FIG. 1, a plurality of coils 20 are arranged on a magnetic metal powder-containing sheet 10a. The coils 20 are alpha-winding coils as shown in FIG. 1. The winding structure of the coils 20 is not particularly limited.

Another magnetic metal powder-containing sheet 10b is stacked on the coils 20 and is pressed, followed by press forming. This allows the coils 20 to be embedded in the magnetic metal powder-containing sheets 10a and 10b and the magnetic metal powder-containing sheets 10a and 10b to be filled in inner portions of the coils 20. Referring to FIG. 1, the magnetic metal powder-containing sheet 10a is placed on the coils 20 and the magnetic metal powder-containing sheet 10b is placed under the coils 20. When the thickness of the magnetic metal powder-containing sheets 10a and 10b is insufficient compared to the thickness of the coils 20, other stacked magnetic metal powder-containing sheets may be placed on and under the coils 20.

The magnetic metal powder-containing sheets 10a and 10b are cured by heating simultaneously with or subsequently to press forming, whereby a cured product is obtained.

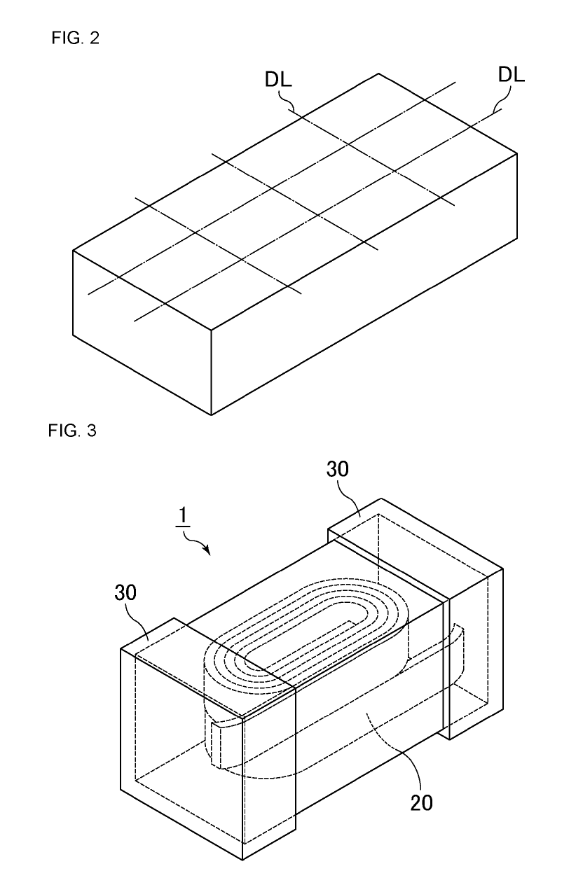

FIG. 2 is a schematic perspective view showing a dicing step. FIG. 3 is a schematic partial perspective view of an inductor obtained by forming outer electrodes.

Referring to FIG. 2, dicing lines are denoted by DL. The cured product is cut into a plurality of inductors by dicing.

Thereafter, outer electrodes 30 are formed on both end surfaces of each inductor, whereby an inductor 1 can be manufactured as shown in FIG. 3.

Inductor

An inductor according to an embodiment of the present invention includes a cured product of a magnetic metal powder-containing sheet according to an embodiment of the present invention and a coil.

In the cured product of the magnetic metal powder-containing sheet that is included in the inductor, particle shedding is suppressed. This allows the inductor to have excellent flexural strength and an excellent L-value.

The coil may be a coiled metal wire (for example, a copper wire). Alternatively, the coil may be a coiled conductor formed on a substrate. The coiled conductor is obtained by, for example, etching or plating a metal film on the substrate. Alternatively, the coiled conductor is obtained in such a manner that a conductivity paste is applied to the substrate so as to form a coil pattern. The substrate may be a resin substrate. The coil is placed in the cured product. Incidentally, an end portion of the coil may be exposed from the cured product.

### EXAMPLES

Examples of the present invention are described below. The present invention is not limited to the examples.

### Example 1

Preparation of Mixture

About 100 parts by weight of an epoxy resin and about 50 parts by weight of a phenoxy resin were prepared. The epoxy resin was a bisphenol A-type liquid epoxy resin with a weight-average molecular weight of about 370. The phenoxy resin was a bisphenol A-type phenoxy resin with a weight-average molecular weight of about 40,000.

Furthermore, about 10 parts by weight of a curing agent, about 1 part by weight of a curing accelerator, and about 5 parts by weight of a silane coupling agent were prepared. The curing agent was dicyandiamide. The curing accelerator was 2-phenylimidazole. The silane coupling agent was γ-glycidyl epoxy silane.

A magnetic metal powder was prepared in such an amount that the content of the magnetic metal powder contained in a magnetic metal powder-containing sheet was about 80% by volume. The magnetic metal powder was an Fe—Si—Cr alloy powder.

These materials were mixed into a mixture.

The mixture was formed into a sheet, whereby the magnetic metal powder-containing sheet was prepared.

The amount of each of the epoxy and phenoxy resins blended in the mixture was shown in the table.

Preparation of Cured Product and Measurement of Degree of Particle Shedding and Flexural Strength

The magnetic metal powder-containing sheet prepared through the above steps was heated at about 180° C. for about 50 minutes in a drying oven, whereby a cured product was prepared.

Six cured products were prepared in substantially the same manner as the above. After a cross section of each cured product was polished, the polished surface was observed with a microscope and the number of shed particles in the magnetic metal powder observed in an about 1 mm² observation region was counted. For the six cured products, counting was performed every about 1 mm². The sum of the numbers of the shed particles was shown as “degree of particle shedding” in the table.

Each cured product was cut to a size (about 1.5 mm×about 4 mm×about 8 mm) sufficient to measure the flexural strength and was subjected to a three-point bending test using a flexural strength meter. Results of flexural strength measurement were shown in the table.

### Examples 2 to 5 and Comparative Examples 1 to 3

Magnetic metal powder-containing sheets were prepared in substantially the same manner as that described in Example 1 except that the amount of each of the epoxy and phenoxy resins blended in the mixture was varied as shown in the table. Cured products were prepared in substantially the same manner as that described in Example 1. Inductors were prepared in substantially the same manner as that described in Example 1. The degree of particle shedding was measured in substantially the same manner as that described in Example 1. The flexural strength was measured in substantially the same manner as that described in Example 1.

Results of these operations were summarized in the table.

In Comparative Example 3, no sheet could be formed and therefore evaluation items were not measured.

TABLE

| | Resin composition | | Evaluation items | |
|---|---|---|---|---|
| | Phenoxy resin | Epoxy resin | Degree of | Flexural |
| | (parts by | (parts by | particle | strength |
| | weight) | weight) | shedding | (MPa) |
| Example 1 | 50 | 100 | 35 | 125 |
| Example 2 | 75 | 100 | 22 | 143 |
| Example 3 | 100 | 100 | 21 | 142 |
| Example 4 | 125 | 100 | 18 | 141 |
| Example 5 | 150 | 100 | 20 | 145 |
| Comparative | 0 | 100 | 132 | 77 |
| Example 1 | | | | |
| Comparative | 17 | 100 | 124 | 86 |
| Example 2 | | | | |

| | | | |
|---|---|---|---|
| Comparative | 200 | 100 | Incapable of forming |
| Example 3 | | | sheet |

Measurement of L-Value of Inductor

The magnetic metal powder-containing sheet prepared in each of Example 3 and Comparative Example 1 and a coil were stacked and were pressed. The magnetic metal powder-containing sheet was cured, whereby a cured product was prepared. The cured product was diced, followed by forming outer electrodes, whereby an inductor was prepared. The prepared inductor was measured for L-value by applying an alternating current to the inductor.

The inductor prepared using the magnetic metal powder-containing sheet prepared in Example 3 had an L-value of about 4.65×10⁻⁷ (H). The inductor prepared using the magnetic metal powder-containing sheet prepared in Comparative Example 1 had an L-value of about 4.45×10⁻⁷ (H).

As shown in the table, in Examples 1 to 5, in which each magnetic metal powder-containing sheet contains the phenoxy resin and the epoxy resin and the content of the phenoxy resin is 50 parts by weight to 150 parts by weight per 100 parts by weight of the epoxy resin, the degree of particle shedding is low and the flexural strength is high. However, in Comparative Examples 1 and 2, in which no phenoxy resin is contained or the content of the phenoxy resin is less than 50 parts by weight, the degree of particle shedding is high and the flexural strength is low. In Comparative Example 3, in which the content of the phenoxy resin is more than 150 parts by weight, handling (processing) is difficult and therefore no sheet could be formed.

In Example 3, a higher L-value is obtained as compared to that in Comparative Example 1. The L-value probably correlates with the degree of particle shedding. Therefore, it is conceivable that a high L-value is obtained in the other examples in which the degree of particle shedding is low.

While preferred embodiments of the invention have been described above, it is to be understood that variations and modifications will be apparent to those skilled in the art without departing from the scope and spirit of the invention. The scope of the invention, therefore, is to be determined solely by the following claims.

What is claimed is:

1. A magnetic metal powder-containing sheet containing:
a magnetic metal powder;
a phenoxy resin; and
an epoxy resin,
wherein a content of the phenoxy resin is 50 to 150 parts by weight per 100 parts by weight of the epoxy resin.

2. The magnetic metal powder-containing sheet according to claim 1, wherein the content of the phenoxy resin is 75 to 125 parts by weight per 100 parts by weight of the epoxy resin.

3. The magnetic metal powder-containing sheet according to claim 1, wherein a content of the magnetic metal powder is 60% to 87% by volume.

4. The magnetic metal powder-containing sheet according to claim 1, wherein a content of the magnetic metal powder is 76% to 82% by volume.

5. The magnetic metal powder-containing sheet according to claim 1, wherein the magnetic metal powder contains at least one magnetic metal material selected from the group consisting of Fe—Si—Cr alloy, iron carbonyl, magnetic iron, silicon steel, iron-aluminum, Alperm, Permendur, Sendust, 45 permalloy, 78 permalloy, supermalloy, Mumetal, Hardperm, iron-based amorphous alloy, and cobalt-based amorphous alloy.

6. The magnetic metal powder-containing sheet according to claim 1, wherein the phenoxy resin is selected from the group consisting of one or more of bisphenol A phenoxy resin, bisphenol F phenoxy resin, bisphenol S phenoxy resin, and bisphenol acetophenone phenoxy resin.

7. The magnetic metal powder-containing sheet according to claim 1, wherein the phenoxy resin has a weight-average molecular weight of 10,000 to 1,000,000.

8. The magnetic metal powder-containing sheet according to claim 1, wherein the phenoxy resin has a weight-average molecular weight of 30,000 to 200,000.

9. The magnetic metal powder-containing sheet according to claim 1, wherein the epoxy resin has a weight-average molecular weight of less than 10,000.

10. The magnetic metal powder-containing sheet according to claim 7, wherein the epoxy resin has a weight-average molecular weight of less than 10,000.

11. The magnetic metal powder-containing sheet according to claim 1, wherein the epoxy resin is selected from the group consisting of one or more of bisphenol A epoxy resin, bisphenol F epoxy resin, bisphenol S epoxy resin, biphenyl epoxy resin, hydrogenated bisphenol A epoxy resin, alicyclic epoxy resin, aliphatic epoxy resin, and naphthalene epoxy resin.

12. The magnetic metal powder-containing sheet according to claim 1, wherein the epoxy resin has a weight-average molecular weight of 1,000 or less.

13. The magnetic metal powder-containing sheet according to claim 1, wherein the magnetic metal powder-containing sheet has a flexural strength of 125 MPa or more after curing.

14. A method for manufacturing an inductor, comprising:
providing a magnetic metal powder-containing sheet a magnetic metal powder, a phenoxy resin, and an epoxy resin, wherein a content of the phenoxy resin is 50 to 150 parts by weight per 100 parts by weight of the epoxy resin;
embedding a coil in the magnetic metal powder-containing sheet;
curing the magnetic metal powder-containing sheet with the coil embedded therein to create a cured product; and
cutting or polishing the cured product.

15. The method for manufacturing an inductor according to claim 14, further comprising partially curing the magnetic metal powder-containing sheet before embedding the coil therein.

16. The method for manufacturing an inductor according to claim 14, wherein the coil is embedded in the magnetic metal powder-containing sheet by pressing.

17. An inductor comprising:
a cured product of the magnetic metal powder-containing sheet according to claim 1; and
a coil embedded in the magnetic metal powder-containing sheet.

18. The inductor according to claim 16, further comprising electrodes electrically connected to the coil.
